(19) United States
(12) Patent Application Publication
(10) Pub. No.: US 2013/0229988 A1
(43) Pub. Date: Sep. 5, 2013

(54) Method and Apparatus for Synchronized Channel Access Among Groups

(71) Applicants: Chittabrata GHOSH, Union City, CA (US); Zhong-Yi Jin, Albany, CA (US); Klaus F. Doppler, Albany, CA (US)

(72) Inventors: Chittabrata GHOSH, Union City, CA (US); Zhong-Yi Jin, Albany, CA (US); Klaus F. Doppler, Albany, CA (US)

(73) Assignee: Nokia Corporation

(21) Appl. No.: 13/410,129

(22) Filed: Mar. 1, 2012

(51) Int. Cl. H04W 4/00

(52) U.S. Cl. 370/329; 370/328

(57) ABSTRACT

In the detailed examples an access point AP assigns each of a plurality of stations to a group, in which at least one group has multiple stations assigned. For each group the AP sets a group-specific medium access interval during which stations who are members of the group are allowed to compete for medium access, and sends a message indicating the group-specific medium access intervals for the respective groups. A station receiving the message determines the group to which it belongs and determines that it is allowed to compete for medium access at least during the medium access interval. Various examples provide options for how the grouping might be made and how the intervals might be dynamically adjusted.

### TECHNICAL FIELD

This invention relates generally to wireless communications, and more specifically is directed toward different periods for channel access contention for different groups of users.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
AP access point (of an IEEE 802.11 network)
DCF distributed coordination function
DIFS distributed or DCF interframe spacing
GrPS grouping parameter set
ID identifier
IEEE institute for electrical and electronics engineers
MAC medium access control
QoS quality of service
STA station (of an IEEE 802.11 network)
WLAN wireless local area network (example, IEEE 802.11)

In many wireless communication systems, devices need to compete on medium access. When the number of devices within a wireless network increases, medium access competition may lead to increased collision rate, delays, and/or power consumption. The known methods may not be sufficient in this kind of situation.

### BRIEF DESCRIPTION OF THE DRAWINGS

FIG. 1 is a schematic overview illustrating one example of a radio environment with one AP and multiple STAs and is an exemplary environment in which these teachings may be practiced to advantage.

FIG. 2 is a timing diagram illustrating sequential radio medium access intervals according to one non-limiting example of these teachings.

FIG. 3 is a timing diagram illustrating non-sequential radio medium access intervals according to another non-limiting example of these teachings.

FIG. 4 is a logic flow diagram that illustrates from the perspective of a STA the operation of a method, and a result of execution by an apparatus of a set of computer program instructions embodied on a computer readable memory, in accordance with the exemplary embodiments of this invention.

FIG. 5 is a logic flow diagram that illustrates from the perspective of an AP the operation of a method, and a result of execution by an apparatus of a set of computer program instructions embodied on a computer readable memory, in accordance with the exemplary embodiments of this invention.

FIG. 6 is a simplified block diagram of two STAs and an AP which are exemplary devices suitable for use in practicing the exemplary embodiments of the invention.

### SUMMARY

In a first exemplary aspect of the invention there is an apparatus which includes at least one processor and at least one memory including computer program code. The at least one memory and the computer program code are configured, with the at least one processor and in response to execution of the computer program code, to cause the apparatus to perform at least the following: receive a message indicating a medium access interval for a group of stations; determine that the apparatus belongs to the group; and determine that the apparatus is allowed to compete for medium access at least during the indicated medium access interval.

In a second exemplary aspect of the invention there is a method which comprises: receiving a message indicating a medium access interval for a group of stations; determining that a station belongs to the group; and determining that the station is allowed to compete for medium access at least during the medium access interval.

In a third exemplary aspect of the invention there is a computer readable memory storing a program of instructions which when executed by at least one processor cause an apparatus to perform: in response to receiving a message indicating a medium access interval for a group of stations, determining that a station belongs to the group; and determining that the station is allowed to compete for medium access at least during the medium access interval.

In a fourth exemplary aspect of the invention there is an apparatus which includes at least one processor and at least one memory including computer program code. The at least one memory and the computer program code are configured, with the at least one processor and in response to execution of the computer program code, to cause the apparatus to perform at least the following: assign each of a plurality of stations to a group, in which at least one group has multiple stations assigned; for each group, set a group-specific medium access interval during which stations which are members of the group are allowed to compete for medium access; and send a message indicating the group-specific medium access intervals for the respective groups.

In a fifth exemplary aspect of the invention there is a method which comprises: assigning each of a plurality of stations to a group, in which at least one group has multiple stations assigned; for each group, setting a group-specific medium access interval during which stations which are members of the group are allowed to compete for medium access; and sending a message indicating the group-specific medium access intervals for the respective groups.

In a sixth exemplary aspect of the invention there is a computer readable memory storing a program of instructions which when executed by at least one processor cause an apparatus to perform: assigning each of a plurality of stations to a group, in which at least one group has multiple stations assigned; for each group, setting a group-specific medium access interval during which stations which are members of the group are allowed to compete for medium access; and sending a message indicating the group-specific medium access intervals for the respective groups.

### DETAILED DESCRIPTION

Certain of the continuing development in the IEEE 802.11 WLAN specifications include support for sensor applications such as for example smart (electrical) grid meter-to-pole sensors. There is an 802.11ah task group that is developing new methods applicable to support a large number of stations (STAs) under a single access point (AP).

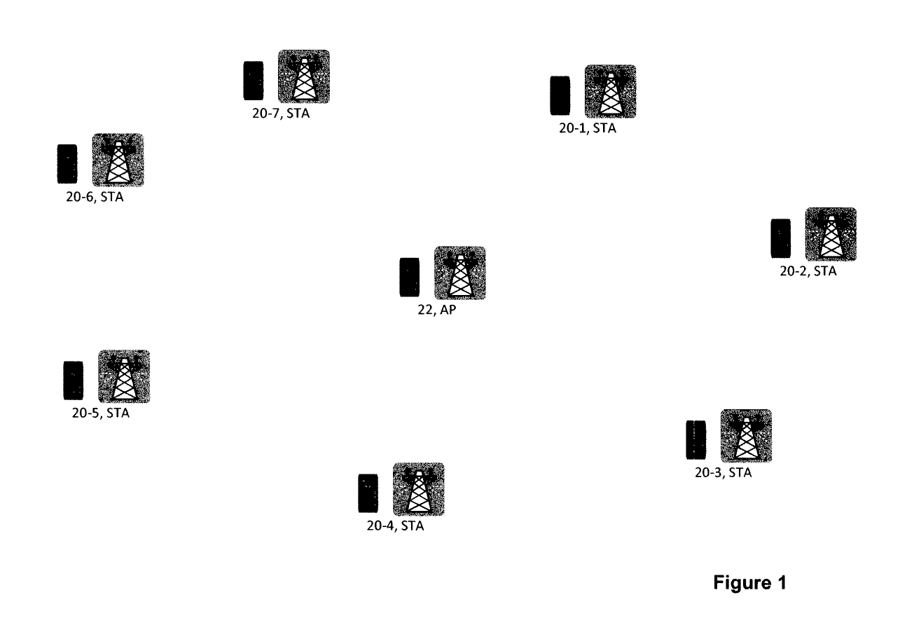

FIG. 1 illustrates an example radio environment consistent with what is envisioned for IEEE 802.11ah: a single AP 22 is serving a large number of STAs 20 (shown as 20-1 through 20-7, but one STA is generically referred to herein as 20) via wireless links, and each STA 20 is associated with an electrical power transmission or distribution line/pole for reporting sensing information to the AP 22 to enable a ‘smart-grid’. In FIG. 1 the AP 22 also is performing sensing on an electrical transmission/distribution pole with which it is associated, which in WLAN terminology makes it an AP-STA. In other relevant radio environments the AP 22 need not also be operating as a STA. Each of the other APs 20 are non-AP STAs.

In WLAN there are contention based and contention free access periods, referring to whether transmitting STAs contend for the wireless medium and are subject to collision with other STA's transmission (contention-based) or whether the STA will be transmitting on a protected radio slot in which other STAs will not be transmitting (contention-free). Relevant to some embodiments of these teachings and to ongoing development of 802.11ah is the contention-based access to which the DCF relates.

In general terms the DCF spreads in time the transmissions on the WLAN by the various STAs by requiring each STA to listen for the channel status for a DCF interframe space (DIFS) interval prior to transmitting in any contention-based period. If the channel is found busy during the DIFS interval, the listening STA defers its transmission. To avoid collisions among multiple STAs that each senses the channel is busy and each defers their access, DCF specifies an additional backoff period during which each STA will additionally wait and listen before transmitting. This reduces the likelihood of transmission collisions because the backoff period is random meaning different STAs will most likely have different backoff periods.

In current proposals to enhance the DCF to more efficiently support a large number of STAs, STAs are divided into groups based on a contention factor Q_n and a prohibition time T_n for a given n^{th} group. Each STA generates a random number r and if r<=Q_n the STA can contend for the channel, otherwise it is prohibited from doing so (and may enter a sleep mode) for the period T_n. See for example documents IEEE 802.11-11/1255r0 (September 2011 by Siyang Liu et al, CATR) and IEEE 802.11-12/0028r0 (January 2012 by Anna Pantelidou et al, Renesas Mobile Corp.).

But network traffic for the sensor scenario of IEEE 802.11 ah is anticipated to be bursty. The inventors consider that the above grouping concept might not be optimum since it is difficult to set up the Q value per group in real time, meaning there will be either congestion if the Q value is set too high or inefficient network usage if the Q value is set too low.

Below is detailed a different approach which the inventors consider more effective, a medium access control (MAC) enhancement which enables synchronized DCF contention among various groups of STAs, such as might be operating in an IEEE 802.11 ah network as one non-limiting embodiment.

In conventional WLAN there is an Association Request message/frame that the STA 20 sends to the AP 22 after authenticating. The Association Request frame carries various fields indicating the capabilities of the STA 20, including Supported Rates, QoS Capability, QoS Traffic Capability, and Power Capability.

In accordance with one non-limiting embodiment the AP 22 uses at least some of these fields to cluster the various STAs into different groups. For example, the AP 22 may base its grouping on access priority requested by the QoS STAs using the QoS Capability and QoS Traffic Capability fields. In another non-limiting embodiment the AP 22 may base its grouping of STAs on non-QoS based parameters, such as for example proximity between non-QoS STAs. The Association Request frame may carry this information to the AP 22. In one embodiment, the QoS/non-QoS information could be carried in a response message to a request received from an access node. In both of the above options, the assigned group may be indicated in some frame other than the association request.

In reply to the Association Request message the AP sends to the requesting STA 20 an Association Response frame which indicates the group ID, along with the conventional Association ID field which associates the STA 20 to the AP 22. In one non-limiting embodiment the group IDs are numbered in descending order of group priority for QoS STAs, and optionally the AP 22 bases its group ID number for the case of non-QoS STAs on their respective association times. This is how the AP 22 may determine which STAs are members of which group. Based on the Association Request frame from a new requesting STA 20, the AP either uses QoS parameters or non-QoS parameters like proximity, etc., to decide to which group the new STA is a member of. The corresponding group ID of the group to which the new STA is assigned is then sent by the AP in reply to the Association Request message. The Association Response frame indicates the group ID, along with the conventional Association ID field which associates the STA 20 to the AP 22.

In conventional WLAN there is also a beacon frame which the AP 22 transmits periodically to announce the WLAN presence. Among other things the conventional beacon frame carries a timestamp field for synchronizing the STAs, a beacon interval which tells when AP 22 is to transmit the next beacon, and capability information which advertises the capability of the AP 22 and of the network (including support for polling and encryption).

In accordance with one non-limiting embodiment of these teachings there is added to the beacon frame a new information element which is termed herein a Grouping Parameter Set (GrPS) information element. There may be other formats for delivering such an information element. In one embodiment this information may be delivered in measurement pilot frames, in addition to or instead of beacon frames. This information element informs the STAs within a group of specific ID about the time till they need to sleep before they can contend for the medium and also their medium access duration. In this non-limiting embodiment the GrPS element shall include: 1) the group ID; 2) the prohibition factor; and 3) the group interval end time. Since this GrPS information element is carried in the beacon frame the grouping is dynamic; in the extreme the AP 22 may place a given STA 20 in one group in one beacon frame and move that STA 20 to another group in a next consecutive beacon frame.

This GrPS element shall be replicated for all possible active groups at any instant. In other words, this GrPS element indicates the group ID, the prohibition factor T_n for the specific group ID set by the AP 22. Since grouping is in one embodiment based on requested access priorities, access to the radio medium in the contention period is also prioritized (from high to low priority) sequentially for this embodiment. But note it is elsewhere detailed herein that grouping may be based on non-QoS parameters such as proximity.

Consider the non-limiting example of group intervals at FIG. 2, assuming there are in total N=5 different groups. Among these N=5 groups, Group 1 has the highest priority and Group 5 has the lowest priority. The Group Interval End Time parameter in the relevant beacon frame indicates the end time of the radio medium access interval for all the STAs in the group identified by a specific group ID. At FIG. 2 the Group Interval End Time for group ID #1 is T_2 reference number 204. With this GrPS information element carried in the beacon frame, the contention factor Q_n noted in the background section above is no longer needed, because all the active STAs within the accessing group ID are allowed to contend simultaneously.

The Group Interval End Time fills in for what is lost by dispensing with the contention factor Q_n, but unlike Q_n which is STA-specific the Group Interval End Time applies for all STAs in the relevant group. In one non-limiting embodiment the value of the Group Interval End Time is a function of the number of associated nodes/STAs in one group. But note that neither the group members nor STAs from other groups need to know how many members are in that group. At minimum only the two parameters Prohibition Factor T_n and Group Interval End Time are needed to inform the STAs in a group about the channel access initiation time (T_1=0 at FIG. 2 for group #1, reference number 202) and the end times (reference #204 for group #1 at FIG. 2). The prohibition interval 206 which terminates for a given group at that group's prohibition factor T_n gives the interval from the group's end time 204 to its next start time 208 at which members of the group are allowed to contend for the radio medium. The interval 206 for group #1 at FIG. 2 assumes the next start time for group #1 is T_6 (reference number 208), which is the same as the end time for group #5 in that non-limiting example. If we assume that there was a preceding group #5 interval immediately prior to the group #1 interval 210 that is illustrated at FIG. 2, then the prohibition interval for group #5 would run from T_1 (which is the end time of that preceding group #5 interval that is not illustrated) until T_5 (which is the start time/prohibition time for the group #5 interval that is illustrated).

In one non-limiting embodiments the length of the group medium access interval 210 (between start time 202 and end time 204) is determined by the AP 22 at least in part by the priority of the group. For example, the AP 22 may form the groups, or at least some of them, by clustering STAs with similar QoS Capability and/or similar QoS Traffic Capability fields into a same group.

From the example at FIG. 2 it can be seen that these teachings enable STAs from all the other N−1 groups to sleep during the channel access period of one specific group out of N groups, so for example all members of group #s 2 through 5 can sleep during the group#1 medium access interval 210.

Even without such a large number of STAs as contemplated by IEEE 802.11ah, from time to time there will be a STA 20 which misses a transmitted beacon frame. In this case, according to a non-limiting embodiment of these teachings that STA 20 may wait until the short beacon in order to learn its GrPS information element. The short beacon contemplated for 802.11ah is sent more frequently than the (regular) beacon. In this case the AP 22 shall include in the short beacon frame all of those group IDs whose Prohibition Times are scheduled between the beacon frame and short beacon frame transmission.

FIG. 2 makes clear that the AP 22 can schedule sequential access of the medium by several groups based on their group IDs, which are set by the AP 22 based on group priorities in this example. Based on that group's medium access priority, STAs in group #1 which has in this example the highest access priority will have the shortest prohibition time 206 and group #5 will have the largest prohibition time. In this non-limiting example the prohibition time T_i for group i may be computed per equation [1] as follows:

T_{—}i=T_(i−1)+k₍ᵢ₋₁₎*T_{—}p, i>=2 [1]

where k₍ᵢ₋₁₎ is a function of number of associated nodes/STAs in the previous group (i−1), and T_p is a constant maximum time defined by the AP 22 for Prohibition Time. An example of T_p may be the period between the beacon and short beacon, e.g., 20 ms. Here, T_1=0, i.e., the first assigned group, has immediate medium access and all other groups will sleep till their scheduled Prohibition Times. As an illustration of the significance of ‘k’, from FIG. 2, Group 2 has the maximum number of associated nodes and hence, prohibition time T_3, or in other words, the medium access time for Group 2 is comparatively larger among the 5 Groups.

In another non-limiting embodiment the variable k in equation [1] above is determined as a function of both the number of STAS in group i and also the priority value for group i which is assigned by the AP 22. That group priority value may in some embodiments account for the QoS parameters of the STAs that are clustered into that group, such as for example the maximum sustainable delay (medium access delay 212 shown at FIG. 2) of applications for STAs in a specific group. Considering the group priority in how the value of ‘k’ is determined allows the AP 22 to impose proportional fairness among groups of QoS STAs.

One advantage for some embodiments in which the AP 22 uses priority-based grouping is that it allows the AP 22 to impose smaller prohibition times 206 as compared to non-QoS STA groups. Smaller prohibition times (206 for group #1) result in smaller medium access delay (212 for group#3) of QoS STA groups as compared to non-QoS STA groups. After a group's initial medium access (for example, during medium access interval 210 at FIG. 2 for group #1), based on the radio medium usage by this group the AP 22 may schedule another slot for its group transmissions. So for example the AP 22 may see a high volume of data being sent by this group and maximum utilization of this assigned medium access duration. The AP interprets that there may be some STAs that did not have channel access due to maximum medium utilization. Hence, the AP may dynamically schedule that same group for another slot. On the contrary, if the AP identifies that the medium is idle during a group's medium access duration, it interprets that there are not enough active STAs in this group. Therefore, the AP reduces the medium access duration for this group in their next assigned slot. This information of the next scheduled slot is transmitted to the groups using the short beacon, which as proposed for IEEE 802.11ah will be transmitted more frequently than once per beacon period (that is, the short beacon is to be transmitted at some sub-multiple of the beacon period). In this manner the STAs in a given group need not wait until the next (full) beacon in the next beacon period for that group's next scheduled radio medium access.

These teachings also provide that the AP 22 may dynamically adjust the length of the radio medium access intervals 210, even apart from scheduling further slots as noted immediately above. For example, using the value k=1 in equation [1] above means the AP 22 is allowing that all the associated nodes for that group, regardless of whether they all have uplink data to send, will theoretically be able to access the channel for a maximum interval of time T_p.

But this is not typical and so in practice the AP 22 may instead begin with a conservative value, for example k=0.1 for each group. The value for k represents the relative amount of time, relative to the overall time shared by all groups, that a given group is allowed for medium access. So if the AP 22 chooses k=0.1 it means the AP is allowing this group 10% of the total time for the STAs in that group to transmit. If during that group's interval 210 the AP 22 observes that the radio medium is idle prior to the Group Interval End Time 204, then the AP 22 may opt to reduce the value of k by 0.05 for this same group in its next radio medium access interval. Or if instead the AP 22 observes that the duration of the interval 210 until the Group Interval End Time 204 is fully utilized by the STAs of that group, then the AP 22 may opt to raise the value of k by 0.1 for this group for that group's next channel access. By equation [1] above, the length of the prohibition time 206 depends from the value of k from the previous group, so the above example adjustments to k result in changes to the length of the radio medium access interval 210 for the group. Therefore, higher the number of associated nodes in the previous group, larger is the Prohibition Time for the next group and vice versa.

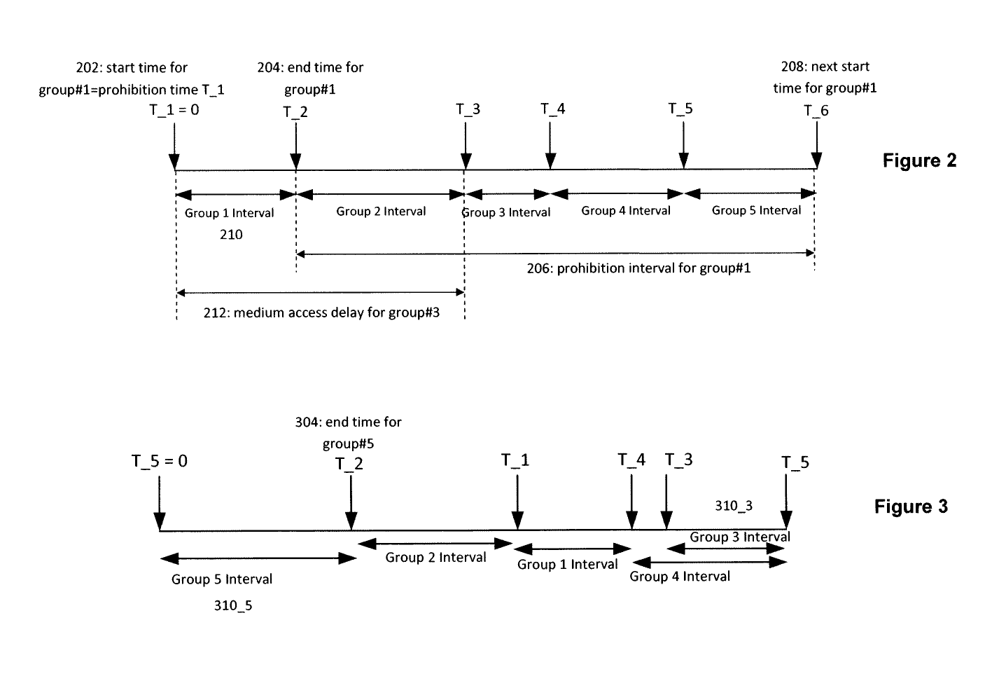

In the sequential medium access shown at FIG. 2, the Group Interval End Time of the current group is the end of the Prohibition Time T_n of the next group in the sequence. So for example at FIG. 2 the medium access interval end time 204 for group#1 coincides with the prohibition end time for group #2, which both occur at T_2. In another embodiment detailed with reference to FIG. 3 there is also the possibility the AP 22 may schedule the medium access intervals for different groups to be non-sequential.

At any point in time, the AP 22 may allow only non-QoS STAs to contend for the radio medium. In such a scenario, the AP 22 may choose to assign group IDs based on the association time of STAs within groups. This type of group ID assignment would then result in non-sequential (in terms of group IDs) medium access. As shown at FIG. 3, the AP 22 can schedule non-sequential access of the radio medium by several groups based on the number of associated STAs per group. In the example shown there, group #5 has the largest number of STA members and consequently the longest medium access interval 310_5 whereas group #3 has the least number of STA members and thus the shortest medium access interval 3103.

In the FIG. 3 example, the prohibition time T_i for group i may be computed according to equation [2] as follows:

T_{—}i=T_(oᵢ−1)+kₒᵢ₋₁*T_{—}p [2]

where oᵢ represents the order of medium access by group i.

In non-sequential medium access of which FIG. 3 is a non-limiting example, the Group Interval End Time of the current group is the Prohibition Time T_n of the next group in the chronological order, and that chronological order is non-sequential as to group IDs. So for example the group interval end time 304 for group #5 at FIG. 3 is also the prohibition time T_2 for group #2. To avoid processing of the information at the STAs, it is useful to readily have the Group Interval End Time field in the GrPS information element. FIG. 3 also illustrates that the medium access time proportionally decreases with decreasing number of STAs per group, as in the above example in which group #5 with the highest number of STAs has a longer medium access interval 310_5 than the medium access interval 310_3 of group #3 which has the least number of STAs.

Also illustrated at FIG. 3 is that different groups may have partially overlapping medium access intervals for simultaneous medium access, shown for group #s 3 and 4. This is useful for groups with equal or nearly equal group size (for example, less than 5 STAs). This option for the AP 22 operates to reduce the medium idle time and thus wasted radio resources when a group with no active STAs contends simultaneously with one or more other groups having only a few active STAs. If there were no overlap then the radio medium would be idle and unused for the entire medium access interval of the group for which no STA were active. The AP 22 generally would not assign such a partial overlapping contention interval for groups with a large number of member STAs, since statistically it is unlikely that all of those large number of STAs will be idle across the entire medium access interval. For example, the AP 22 generally would not assign group #s 5 and 3 to contend for the radio medium simultaneously since there are a large number of STAs in group #5, but since group #4 has only a few stations the AP 22 may find it efficient to have some overlap in the medium access intervals for group #s 3 and 4.

From the above examples it is shown that by enabling a relatively long prohibition interval 206 for STAs, these teachings can result in quite a large savings of the STA's limited power supply (for the case the STAs run on a battery/fuel cell or other limited power supply). Power conservation is an important consideration in development of the IEEE 802.11ah technical standards. This power savings follows from the approaches summarized in the background section wherein the STA needs to wake-up and compare a newly generated r value against a contention factor Q_n to determine the next time it is allowed to contend for the radio medium.

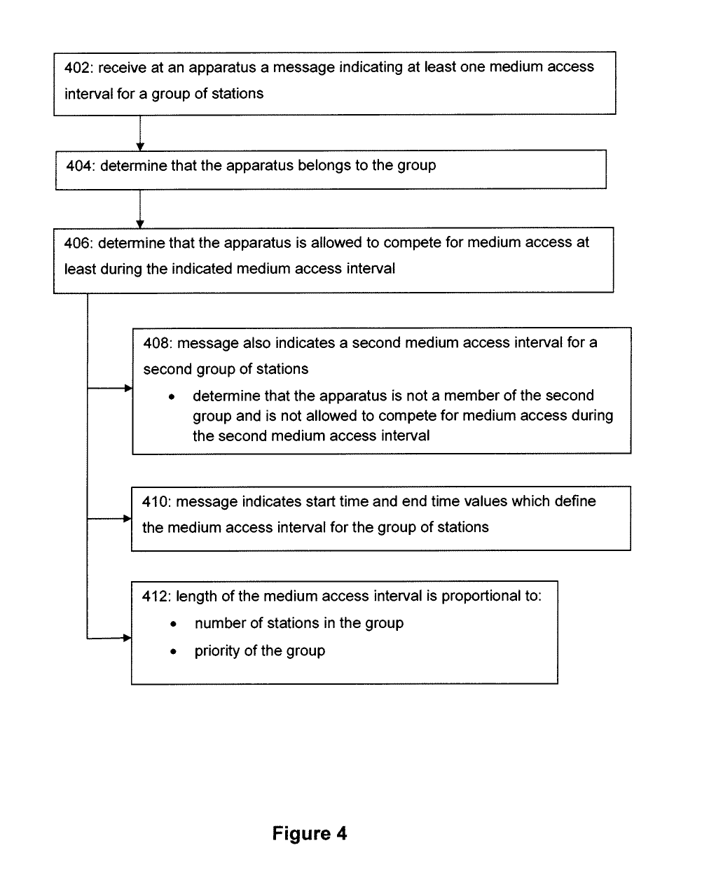

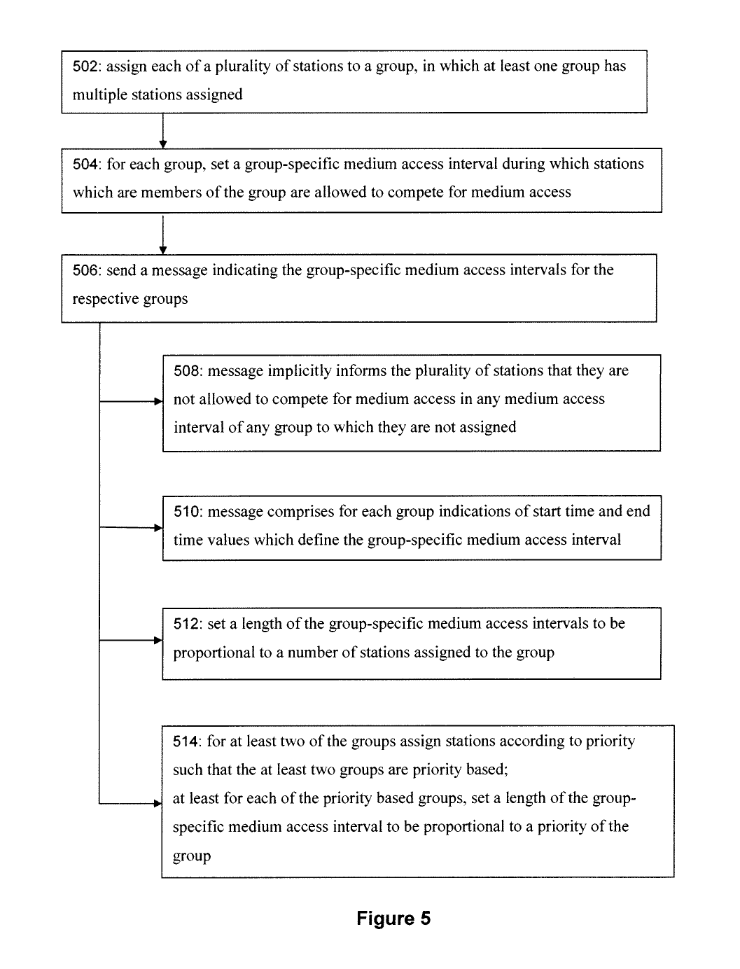

The logic flow diagrams of FIGS. 4-5 summarize some of the non-limiting and exemplary embodiments of the invention from the perspective of the STA 20 or certain components thereof if not performed by the entire STA (FIG. 4), and from the perspective of the AP 22 or certain components thereof if not performed by the entire AP (FIG. 5). These Figures may each be considered to illustrate the operation of a method, and a result of execution of a computer program stored in a computer readable memory, and a specific manner in which components of an electronic device are configured to cause that electronic device to operate, whether such an electronic device is the access node in full or one or more components thereof such as a modem, chipset, or the like.

The various blocks shown at FIGS. 4-5 may also be considered as a plurality of coupled logic circuit elements constructed to carry out the associated function(s), or specific result of strings of computer program code or instructions stored in a memory. Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

First consider FIG. 4 which is from the perspective of the STA. At block 402 of FIG. 4 the STA 20 (or one or more components thereof) receives a message indicating a medium access interval for a group of stations. Then at block 404 the STA determines that it belongs to the group and from that it also determines at block 406 that it is allowed to compete for medium access at least during the indicated medium access interval. Note the STA does not have to compete; it may not have data to send during that medium access interval. But this is how the STA finds those intervals in which it is allowed to compete. This also differs from the approaches detailed in the background section in that the interval for accessing the wireless medium is group-wide rather than particular for individual stations. While it is possible the AP might assign only one STA to a group, for purposes of FIG. 4 assume there are at least two STAs in the group.

Further portions of FIG. 4 reflect further non-limiting details from the example embodiments above. Block 408 gives examples the STA's treatment of other group's intervals. If we consider the medium access interval of block 402 as a first medium access interval for a first group of stations, then that same message also indicates a second medium access interval for a second group of stations. The STA then determines that it is not allowed to compete for medium access during the second medium access interval, since it never determined it was a member of that second group.

Block 410 details that the message, which in the above examples is a beacon frame received by the STA 20 from an AP 22, comprises indications of start time and end time values which define the medium access interval for the group of stations that was first stated at block 402.

And finally block 412 details certain characteristics of the medium access interval of block 402, namely that the length of the medium access interval is proportional to (or more generally based at least partly on) a number of stations in the group, and/or proportional to (or more generally based at least partly on) a priority of the group of stations. But while the STA will know the length of its wireless medium access interval, it may not know how many other members are in its own group, or even whether the AP 22 used QoS priority in making priority-specific groups.

Now consider FIG. 5 which is from the perspective of the AP. At block 502 of FIG. 5 the AP 22 assigns each of a plurality of stations to a group, in which at least one group has multiple stations assigned. Typically for the 802.11 ah deployment every group will have multiple stations assigned. Note also that the AP may assign each station to only a single group, or may assign one or more stations to multiple groups depending on how the AP does its grouping. Then at block 504 the AP 22, for each group, sets a group-specific medium access interval during which stations which are members of the group are allowed to compete for medium access. And then at block 506 the AP 22 sends a message indicating the group-specific medium access intervals for the respective groups.

Further portions of FIG. 5 reflect further non-limiting details from the example embodiments above. Block 508 tells that the message of block 506 implicitly informs the plurality of stations that they are not allowed to compete for medium access in any medium access interval of any group to which they are not assigned. Block 510 of FIG. 5 details that the message comprises for each group indications of start time and end time values which define the group-specific medium access interval.

Blocks 512 and 514 summarize the above examples concerning the relative lengths of those medium access intervals. Block 512 further details block 504 where the AP sets the group-specific medium access intervals. For block 512 the AP 22 does this by setting a length of the group-specific medium access intervals to be proportional to (or more generally based at least partly on) a number of stations assigned to the group (which were assigned at block 502). Block 514 gives another approach which may or may not be combined with block 512, namely that for at least two of the groups formed at block 502 stations are assigned according to priority. For convenience call these groups priority based. Then block 514 specifies that for the intervals set up at block 504 the AP, at least for each of the priority based groups, sets a length of the group-specific medium access interval to be proportional to (or more generally based at least partly on) a priority of that priority based group.

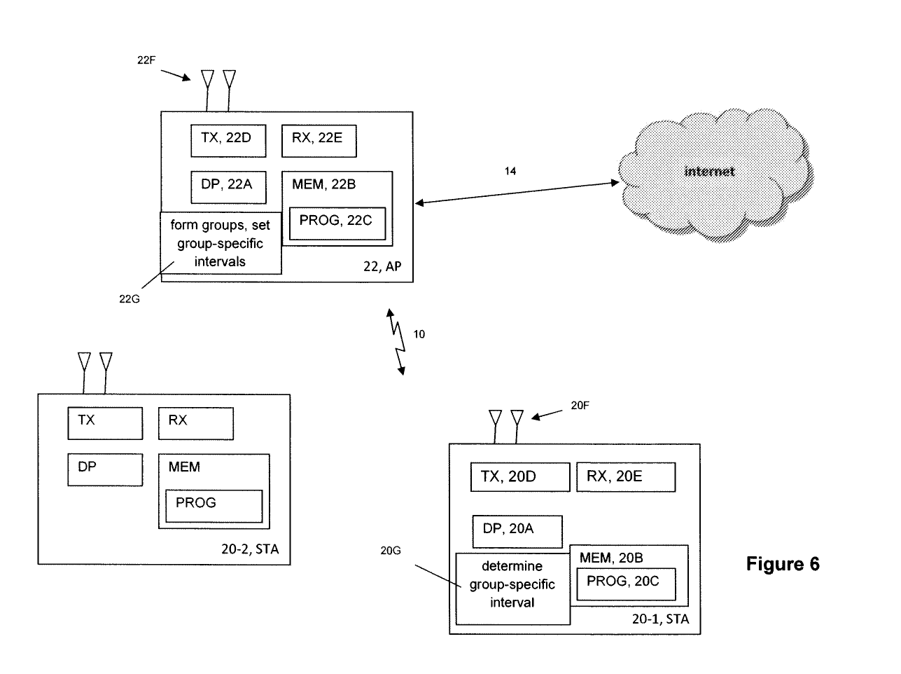

Reference is now made to FIG. 6 for illustrating a simplified block diagram of various electronic devices and apparatus that are suitable for use in practicing the exemplary embodiments of this invention. In FIG. 6 an AP 22 is adapted for communication over a wireless medium/link 10 with an apparatus, such as a mobile device/terminal or a radio-equipped sensor or a user equipment, all of which stand in the place of the AP 20 in the examples above. FIG. 6 shows only two STAs 20-1 and 20-1 but as noted above with respect to FIG. 1 there may be up to several thousand STAs served by a single AP 22. The AP 22 may be any access node (including frequency selective repeaters) of any wireless network such as WLAN in the examples above, or it may be an access node (Node B, e-Node B, base station, etc) that utilizes some other radio access technology such as for example cellular technologies LTE, LTE-A, GSM, GERAN, WCDMA, and the like which each use a contention period in their random access procedures and which may be adapted for machine-to-machine communications in which grouping according to these teachings may provide similar advantages. The various STAs may also form a cognitive radio network, with one of the cognitive radios or a node of a formal network taking on the functions detailed above for the AP. The AP 22 provides the STAs 20-1, 20-2 with connectivity to further networks via data link 14(for example, a data communications network/Internet as shown and/or a publicly switched telephone network).

One STA 20-1 is detailed below but the other STA 20-2 is functionally similar though it may be not be identical or even made by the same manufacturer. The STA 20 includes processing means such as at least one data processor (DP) 20A, and storing means such as at least one computer-readable memory (MEM) 20B storing at least one computer program (PROG) 20C or other set of executable instructions. In some embodiments the STA 20 may also include communicating means such as a transmitter TX 20D and a receiver RX 20E for bidirectional wireless communications with the AP 22 via one or more antennas 20F. If the AP 22 puts those two STAs 20-1 and 20-2 in the same group they may need to content with one another for the channel 10, but if they are not in the same group they will not contend with one another but only with other STAs assigned to their respective groups. Also stored in the MEM 20B at reference number 20G is the UE's algorithm or function or selection logic for determining its own group-specific medium access intervals from the AP's message/beacon as detailed above in various non-limiting examples.

The AP 22 may comprise processing means such as at least one data processor (DP) 22A, storing means such as at least one computer-readable memory (MEM) 22B storing at least one computer program (PROG) 22C or other set of executable instructions. The AP22 may also comprise communicating means such as a transmitter TX 22D and a receiver RX 22E for bidirectional wireless communications with the STA 20, for example via one or more antennas 22F. The AP 22 may store at block 22G the algorithm or function or selection logic for assigning STAs to groups and for setting the group-specific interval for wireless medium access as set for by non-limiting examples above.

At least one of the PROGs 22C/22G and in the AP 22, and PROGs 20C/20G in the STA 20, is assumed to include a set of program instructions that, when executed by the associated DP 22A/20A, may enable the device to operate in accordance with the exemplary embodiments of this invention, as detailed above. In these regards the exemplary embodiments of this invention may be implemented at least in part by computer software stored on the MEM 20B, 22B which is executable by the DP 20A of the STA 20 and/or by the DP 22A of the AP 22, or by hardware, or by a combination of tangibly stored software and hardware (and tangibly stored firmware). Electronic devices implementing these aspects of the invention need not be the entire devices as depicted at FIG. 6 but may be one or more components of same such as the above described tangibly stored software, hardware, firmware and DP, or a system on a chip SOC or an application specific integrated circuit ASIC.

In general, the various embodiments of the STA 20 can include, but are not limited to digital devices having wireless communication capabilities such as radio devices with sensors operating in a machine-to-machine type environment or personal portable radio devices such as but not limited to cellular telephones, navigation devices, laptop/palmtop/tablet computers, digital cameras and music devices, and Internet appliances.

Various embodiments of the computer readable MEMs 20B, 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the WLAN and IEEE 802.11ah system, as noted above the exemplary embodiments of this invention may be used with various other types of wireless communication systems such as for example cognitive radio systems or cellular systems as presently in use or as adapted over time in the future to handle machine to machine type communications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus comprising
at least one processor; and
at least one memory including computer program code;
in which the at least one memory and the computer program code is configured, with the at least one processor, to cause the apparatus at least to:
receive a message indicating a medium access interval for a group of stations;
determine that the apparatus belongs to the group; and
determine that the apparatus is allowed to compete for medium access at least during the medium access interval.

2. The apparatus according to claim 1, wherein the said medium access interval is a first medium access interval for a first group of stations and the message indicates a second medium access interval for a second group of stations;
and the at least one memory and the computer program code is configured with the at least one processor to cause the apparatus at least further to determine that the apparatus is not allowed to compete for medium access during the second medium access interval.

3. The apparatus according to claim 1, in which the message comprises indications of start time and end time values which define the medium access interval for the group of stations.

4. The apparatus according to claim 1, in which a length of the medium access interval is based at least partly on a number of stations in the group.

5. The apparatus according to claim 1, in which a length of the medium access interval is based at least partly on a priority of the group of stations.

6. The apparatus according to claim 1, in which the apparatus comprises a station for a wireless local area network or one or more components thereof; and the message comprises a beacon received from an access point.

7. A method comprising:
receiving a message indicating a medium access interval for a group of stations;
determining that a station belongs to the group; and
determining that the station is allowed to compete for medium access at least during the medium access interval.

8. The method according to claim 7, wherein the said medium access interval is a first medium access interval for a first group of stations and the message indicates a second medium access interval for a second group of stations;
the method further comprising determining that the station is not allowed to compete for medium access during the second medium access interval.

9. The method according to claim 7, in which the message comprises indications of start time and end time values which define the medium access interval for the group of stations.

10. The method according to claim 7, in which a length of the medium access interval is based at least partly on a number of stations in the group.

11-12. (canceled)

13. An apparatus comprising
at least one processor; and
at least one memory including computer program code;
in which the at least one memory and the computer program code is configured, with the at least one processor, to cause the apparatus at least to:
assign each of a plurality of stations to a group, in which at least one group has multiple stations assigned;
for each group, set a group-specific medium access interval during which stations which are members of the group are allowed to compete for medium access; and
send a message indicating the group-specific medium access intervals for the respective groups.

14. The apparatus according to claim 13, wherein the message implicitly informs the plurality of stations that they are not allowed to compete for medium access in any medium access interval of any group to which they are not assigned.

15. The apparatus according to claim 13, in which the message comprises for each group indications of start time and end time values which define the group-specific medium access interval.

16. The apparatus according to claim 13, in which setting the group-specific medium access intervals comprises setting a length of the group-specific medium access intervals to be based at least partly on a number of stations assigned to the group.

17. The apparatus according to claim 13, in which
assigning each of a plurality of stations to a group comprises, for at least two of the groups, assigning stations according to priority such that the at least two groups are priority based; and
setting the group-specific medium access intervals comprises, at least for each of the priority based groups, setting a length of the group-specific medium access interval to be based at least partly on a priority of the priority based group.

18. The apparatus according to claim 13, in which the apparatus comprises an access point for a wireless local area network or one or more components therefore; and the message comprises a beacon transmitted by the access point.

19. A method comprising
assigning each of a plurality of stations to a group, in which at least one group has multiple stations assigned;
for each group, setting a group-specific medium access interval during which stations which are members of the group are allowed to compete for medium access; and
sending a message indicating the group-specific medium access intervals for the respective groups.

20. The method according to claim 19, wherein the message implicitly informs the plurality of stations that they are not allowed to compete for medium access in any medium access interval of any group to which they are not assigned.

21. The method according to claim 19, in which the message comprises for each group indications of start time and end time values which define the group-specific medium access interval.

22. The method according to claim 19, in which setting the group-specific medium access intervals comprises setting a length of the group-specific medium access intervals to be based at least partly on a number of stations assigned to the group.

23-24. (canceled)
